(19) United States
(12) Patent Application Publication
(10) Pub. No.: US 2026/0030051 A1
(43) Pub. Date: Jan. 29, 2026

(54) SYSTEM FOR TRANSFERRING WORKFLOWS BETWEEN SOFTWARE APPLICATIONS

(71) Applicant: Microsoft Technology Licensing, LLC, Redmond, WA (US)

(72) Inventors: Chenguang YANG, Seattle, WA (US); Tanmay VARSHNEY, Noida (IN); Deepesh SATIJA, Delhi (IN); Haris SYED, Redmond, WA (US)

(21) Appl. No.: 18/785,551

(22) Filed: Jul. 26, 2024

(51) Int. Cl. G06F 9/48; G06F 9/54; G06F 16/955

(52) U.S. Cl. CPC G06F 9/4806; G06F 9/546; G06F 16/955

(57) ABSTRACT

Systems, methods, and software are disclosed herein for transferring a workflow from a source application to a destination application in various implementations. In an implementation, a computing apparatus receives a request from a source application to hand off a workflow to a destination application. In response to the request, the computing apparatus generates a handoff link for transferring the workflow from the source application to the destination application and transmits the handoff link to the source application.

### TECHNICAL FIELD

Aspects of the disclosure are related to the field of software applications and particularly to services for transferring data between applications.

### BACKGROUND

Software applications, particularly productivity applications, typically support a broad range of functionalities which may overlap with other applications. For example, a user working with structured data can create a data table in a word processing document rather than in a spreadsheet. However, the word processing application may only support basic mathematical operations for the data table in the word processing document as compared to a spreadsheet application. Thus, despite the broad range of functionality, accessing more advanced application functionalities may require the user to switch to another, dedicated application—that is to say, the boundaries between applications may overlap, but that only goes so far. The core competencies of productivity applications still remain largely siloed.

Given the more or less singular focus of productivity applications, users may be tasked with projects which require the user to work across multiple applications to produce end products in a variety of formats. For example, a user drafting a research paper on a particular topic may also need to create a slide deck for a presentation on the topic based on the paper and to draft an email to announce the presentation. Thus, the user will end up working within multiple application environments, inefficiently duplicating and adapting the project content to multiple formats according to the desired end product. Moreover, switching between applications can be time-consuming, laborious, and disruptive to the user's workflow.

The integration of generative artificial intelligence (AI) tools in productivity applications has significantly improved the utility of productivity applications for ideation and content development. This expanded capability enables users to be more productive and to complete projects involving content generation and development more quickly and more efficiently. However, despite the advantages of integrated generative AI tools, users tasked with developing content for projects that cross application boundaries may still find themselves hobbled by application boundaries.

### Overview

Technology is disclosed herein for transferring a workflow from a source application to a destination application in various implementations. In an implementation, a computing apparatus comprises one or more computer readable storage media and one or more processors operatively coupled with the one or more computer readable storage media, and program instructions stored on the one or more computer readable storage media that, when executed by the one or more processors, direct the computing apparatus to at least receive a request from a source application to handoff a workflow to a destination application; in response to the request, to generate a handoff link for transferring the workflow from the source application to the destination application; and transmit the handoff link to the source application.

In an implementation, a method of operating a computing device includes receiving a request from a source application to handoff a workflow to a destination application; in response to the request, generating a handoff link for transferring the workflow from the source application to the destination application; and transmitting the handoff link to the source application.

In an implementation, one or more computer readable storage media having program instructions stored thereon that, when executed by one or more processors, direct a computing apparatus to at least receive a request from a source application to handoff a workflow to a destination application; in response to the request, to generate a handoff link for transferring the workflow from the source application to the destination application; and transmit the handoff link to the source application.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for transferring workflows between applications in an implementation.

FIG. 2 illustrates a process for transferring workflows between applications in an implementation.

FIG. 3 illustrates an operational environment for transferring workflows between applications in an implementation.

FIG. 4 illustrates a process for transferring workflows between applications in an implementation.

FIGS. 5A-5E illustrate a user experience for transferring workflows between applications in an implementation.

FIG. 6 illustrates a computing system suitable for implementing the various operational environments, architectures, processes, scenarios, and sequences discussed below with respect to the other Figures.

### DETAILED DESCRIPTION

Various implementations are disclosed herein for technology for automating the process of porting a workflow from a source context to a destination context and continuing the workflow in the destination context. In an exemplary scenario, a user creating or developing content in a one context (e.g., a source application) desires to continue his or her workflow in another context (e.g., a destination application). The user prompts an AI agent of the source context with a natural language request reflecting this desire to transfer to the other context. Receiving the user's request triggers a handoff orchestrator to coordinate the workflow transfer from the AI agent of the source context to an AI agent of the destination context.

In various implementations, an AI agent (or “agent”) of an application is a service or functionality of the application by which a generative AI model or engine is integrated into the application. The AI agent may host conversational exchanges between a user of the application and the generative AI model. For example, the application may display a window or pane for the agent in the user interface of the application where the user can submit requests to the generative AI model and receive output generated in response to the request. The AI agent mediates the exchange by prompting the model to return its output in a parse-able format to facilitate display in the user interface or to perform an action in the application. In this way, the response to a user query can cause an automated response by the application (e.g., implement a desired change to the user's content). The AI agent may be specialized and optimized for tasks which are specific to the hosting application.

In a brief, high-level illustration of the technology in operation, a user developing content in a document of a word processing application submits a request to the AI agent of the word processing application (“first agent”) to further develop the content as a slide presentation. For example, the user may enter, “transform this document to a presentation” in a chat pane of the first agent. The first agent detects that a handoff is implied or invoked in the user's request. The first agent calls a handoff orchestrator to obtain a handoff link for executing a handoff of the content development to the AI agent of a slide presentation application (“second agent”) including transferring the content of the document to the slide presentation application. The first agent displays the handoff link created by the handoff orchestrator in the user interface of the word processing application. As displayed, the link indicates that when the user clicks on it, the content will be transferred to a slide presentation application for further development. When the user clicks on the handoff link, the slide presentation application is launched, and the second agent performs steps to further develop the content as a slide presentation per the user's request.

In various implementations of the technology disclosed herein, a handoff orchestrator coordinates handoffs (i.e., workflow transfers) from a source application to destination application. When a request for a handoff is received, the handoff orchestrator executes its own handoff workflow, including requesting a link from the destination application by which to launch the destination application (e.g., to open a blank document or canvas in the destination application) to receive the workflow content. The launch link also includes a parameter causing the destination application to launch its agent. The handoff orchestrator stores information relating to the handoff, such as the user's natural language request or a chat history of conversation between the user and the source agent, in a message store for later retrieval by the destination agent. In some cases, the handoff orchestrator stores the workflow content in the message store along with other handoff information for retrieval by the destination application. In other cases, the handoff orchestrator stores information (e.g., an application programming interface (API) call or link) by which the destination application or its agent can call the source application (e.g., an API of the source application) to retrieve the workflow content.

Continuing with the handoff workflow, the handoff orchestrator creates a handoff link by which the user can execute the transfer of the workflow from the source application to the destination application. The handoff link includes the launch link, boot parameters for the agent of the destination application (“destination agent”), and a message key or identifier received from the message store when the handoff information was stored. Having configured the handoff link for triggering the handoff, the handoff orchestrator returns the handoff link to the source application for display in the user interface, such as in a chat pane of the agent of the source application (“source agent”).

When the user clicks on the handoff link, the process of transferring the workflow is initiated. The source application causes the destination application to be launched using the launch link. The destination agent is booted according to the boot parameters in the handoff link, and the destination agent accesses the message store to retrieve the handoff information, including the user input, using the message identifier in the handoff link. Based on the user input retrieved from the message store, the destination agent then picks up where the user request or conversation left off to continue with transferred workflow.

In various implementations, the agents participating in handoffs between source and destination contexts are services or functionalities for generative artificial intelligent (AI) integrations of their respective applications. An agent may be a service which hosts an API by which a source or destination application transmits and receives task information, including output generated by a generative AI model, or the agent may be a functionality hosted by a respective application. In exemplary usage, an agent may participate in conversational exchanges with a user in a chat pane of the user interface of an application. In its interactions with the user, the agent prompts a generative AI model, such as a large language model (LLM) or other type of foundation model, to generate responses to the user queries, including contextual information (e.g., document content, conversational history) in the prompts to cause the model to generate focused, relevant responses. In the context of handing off workflows between applications, when the generative AI model detects that the user input invokes a handoff request, the generative AI model returns an indication to the agent to call the handoff orchestrator to coordinate the transfer. The generative AI model may also indicate in its response which application should receive the to-be-transferred workflow.

In various implementations, the handoff orchestrator is an application or service which coordinates handoffs between contexts or applications. In some scenarios, the handoff orchestrator is a service of a source or destination application or an inter-application service for a suite of applications. In operation, when the handoff orchestrator receives a request for a handoff, the handoff orchestrator interfaces with a generative AI model to create a handoff link, prompting the model to configure the link according to various inputs, such as the user input, the message identifier, the type of source application, the nature of the workflow content, the type of transfer or content transformation stated or detected in the user input, the types of destination applications which are available to continue the workflow, and so on. The generative AI models accessed by the various participants of a handoff workflow may be different from each other. For example, an LLM may be fine-tuned to perform a specific set of tasks for the service of functionality calling it. In some scenarios, the handoff orchestrator orchestrates the activity of a number of software-defined agents (e.g., AutoGen agents), each of which interfaces with a generative AI model to perform a particular activity of the handoff workflow.

Generative AI models of the technology disclosed herein include large-scale foundation models trained on massive quantities of diverse, unlabeled data using self-supervised, semi-supervised, or unsupervised learning techniques. Such models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. Foundation models include BERT (Bidirectional Encoder Representations from Transformers) and ResNet (Residual Neural Network). In some scenarios, a foundation model may be fine-tuned for specific downstream tasks. Fine-tuning a foundation model involves adjusting the parameters of the pretrained model according to a specific dataset to adapt the model's output to a particular task. Types of foundation models may be broadly classified as or include pre-trained models, base models, and knowledge models, depending on the particular characteristics or usage of the model. Foundation models may be multimodal or unimodal depending on the modality of the inputs.

Large language models (LLMs) are a type of foundation model which processes and generates natural language text. These models are trained on massive amounts of text data and learn to generate coherent and contextually relevant responses given a prompt or input text. LLMs are capable of understanding and generating sophisticated language based on their trained capacity to capture intricate patterns, semantics and contextual dependencies in textual data. In some scenarios, LLMs may incorporate additional modalities, such as combining images or audio input along with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge Integration) models, T5 (Text-to-Text Transfer Transformer), and XLNet models are types of transformer models which have been pretrained on large amounts of text data using a self-supervised learning technique called masked language modeling. Such pretraining allows the models to learn a rich representation of language that can be fine-tuned for specific NLP tasks, such as text generation, language translation, or sentiment analysis.

Technical advantages of the technology disclosed herein include a streamlined user experience in which the AI agents can seamlessly delegate tasks to each other when the user request exceeds the capabilities of one agent but can be resolved by another agent. In streamlining the user experience, user engagement is promoted in that complex multi-step tasks (e.g., transferring content from one context to another) are automated for the user. In addition to saving the user time, the technology can be used by users of any skill level and reduces errors in the final production. Further, the integration with generative AI model technology avoids complicating the user interface by adding graphical elements such as buttons or dropdown menus for the handoff functionality to the user interface.

In addition to a streamlined user experience, the technology enables more rapid convergence toward a desirable outcome which in turn reduces compute costs (e.g., processor usage, time). The user is able to achieve the desired outcome based on the automated handoff and content handling. With less manual intervention, the process can be accomplished with less user interaction and less reliance on user interfaces of the applications.

Technical effects also include simplified software development—the software development is significantly reduced from would be necessary for deterministic algorithms to accomplish what can be accomplished via generative AI model or foundation model integrations. Simplified software development also reduces development time and software complexity, which in turn makes the software easier to debug and to maintain.

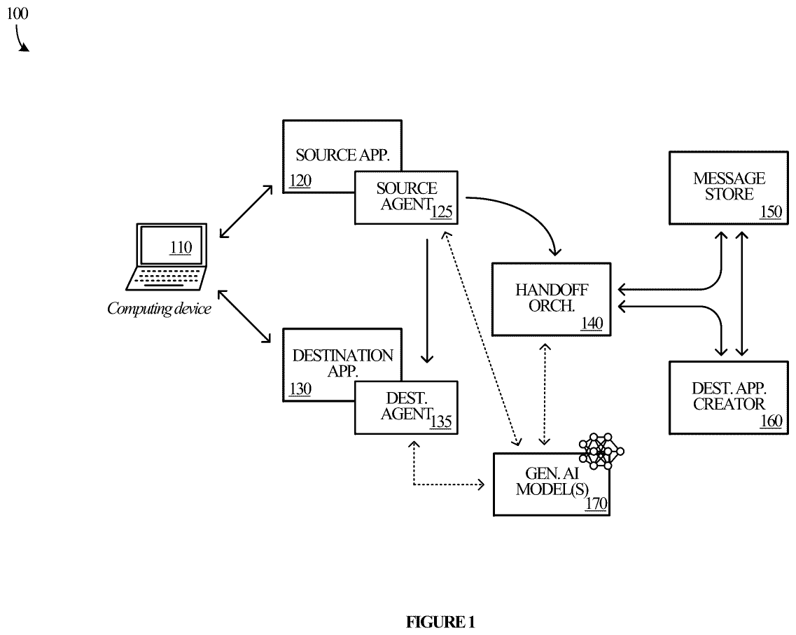

Turning now to the Figures, FIG. 1 illustrates operational environment 100 for transferring workflows between application agents in an implementation. Operational environment 100 includes computing device 110, source application 120, source agent 123, destination application 130, and destination agent 135. Source agent 125 communicates with handoff orchestrator 140 which in turn communicates with message store 150 and destination application creator 160. Source agent 125, destination agent 135, and handoff orchestrator 140 also communicate with generative AI model 170.

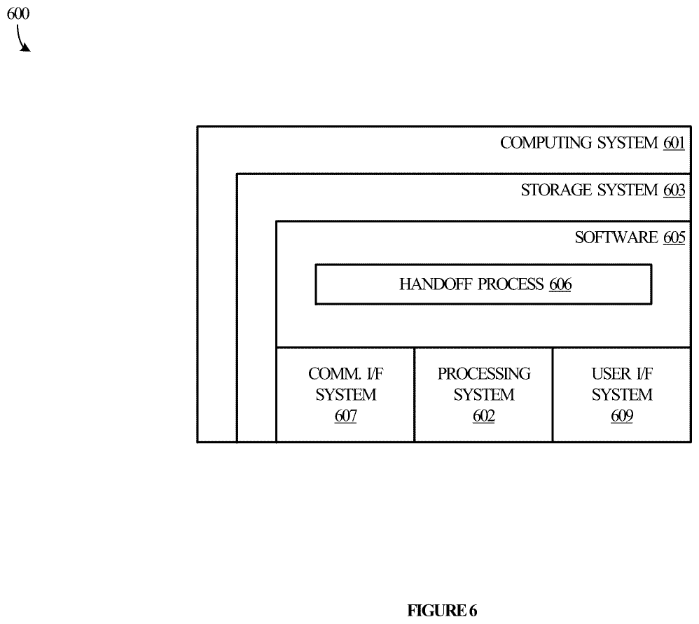

Computing device 110 is representative of a computing device, such as a laptop or desktop computer, or mobile computing device, such as a tablet computer or cellular phone, of which computing system 601 in FIG. 6 is broadly representative. Computing device 110 communicates with source application 120, destination application 130, and their respective agents via one or more internets and intranets, the Internet, wired or wireless networks, local area networks (LANs), wide area networks (WANs), and any other type of network or combination thereof. A user may interact with source application 120, destination application 130, and their respective agents via user interfaces of the applications displayed on computing device 110.

Source application 120 and destination application 130 are representative of software applications for various types of content creation and development, such as productivity applications, collaborative applications (e.g., project management applications), web browsers, and so on. Source application 120 and/or destination application 130 may execute locally on a user computing device, such as computing device 110, or source application 120 and destination application 130 may execute on one or more servers in communication with computing device 110 over one or more wired or wireless connections, causing a user interface for the respective application to be displayed on computing device 110. In some scenarios, source application 120 and/or destination application 130 may execute in a distributed fashion, with a combination of client-side and server-side processes, services, and sub-services. For example, the core logic of source application 120 may execute on a remote server system with a user interface for the application displayed on a client device. In still other scenarios, computing device 110 is a server computing device, such as an application server, capable of displaying a user interface for source application 120 or destination application 130 which execute locally with respect to computing device 110.

Source application 120 or destination application 130 executing locally with respect to computing device 110 may execute in a stand-alone manner, within the context of another application such as a presentation application or word processing application, or in some other manner entirely. In an implementation, source application 120 or destination application 130 hosted by a remote application service, and running locally with respect to computing device 110 may be a natively installed and executed application, a browser-based application, a mobile application, a streamed application, or any other type of application capable of interfacing with the remote application service and providing local user experiences displayed in a user interface on the remote computing device.

In some implementations, computing device 110 executes source application 120 or destination application 130 locally which provides a local user experience. Source application 120 or destination application 130 running locally with respect to computing device 110 may be a natively installed and executed application, a browser-based application, a mobile application, a streamed application, or any other type of application capable of interfacing with a generative AI model such as generative AI model 170 and providing a user experience displayed on computing device 110. Source application 120 or destination application 130 may execute in a stand-alone manner, within the context of another application, or in some other manner entirely.

Agents 125 and 135 are representative of a service or functionality by which a hosting application can interface with a generative AI model such as generative AI model 170, including mediating dialog between a user and the AI model and automating actions in the hosting application based on a user query. Generative AI model integrations via agents 125 and 135 provide semantic understanding of users' natural language inputs to assist the user in using the application, to make recommendations to the user with respect to content development or application use to users, and to facilitate activity within the application, such as detecting an intent of the user to transfer content to a new context from the current context. For example, a user can seek assistance with content development, application usage, and other topics by submitting a natural language query, keyed in or spoken, in a chat pane of agents 125 and 135 and receive output from generative AI model 170 which resolves the user's query. A user may also submit a query which causes the agent to perform an action in the application based on output generated by the model in response to the query. Agents 125 and 135 may be applications or services which host an API by which an application, such as source application 120 or destination application 130, transmits requests or queries for prompts to a generative AI model and receives output generated by the model in response to the prompts. Alternatively, agents 125 and 135 may be functionalities hosted by source application 120 or destination application 130, respectively.

Agents 125 and 135 enable the integration of generative AI model 170 with source application 120 and destination application 130, respectively. For example, agent 125 of source application 120 generates prompts based on a user query for submission to generative AI model 170, receives output from the model based on the prompts, and formats the output for display in the user interface of the application. In some scenarios, agents such as agents 125 and 135 may access a generative AI model which has been fine-tuned for a specific domain or application based on application- or task-specific data. For example, a large language model may be fine-tuned according to the options or selections which are available for formatting text in a document hosted in a word processing application. Based on a user query, the model may generate a recommendation in natural language about text formatting or the model may generate a data object which causes the application to automatically reformat the text in response to the user query.

Handoff orchestrator 140 is representative of a service or functionality by which an agent of one context can transfer a workflow to the agent of another context, including interfacing with datastores or message stores, such as message store 150, and application APIs or creators, such as destination application creator 160. Handoff orchestrator 140 may interface with a generative AI model, such as a large language model, to generate handoff links by which a user can initiate a workflow transfer from a source context or application to a destination context or application. In some scenarios, handoff orchestrator 140 is a service accessible by applications of a suite of applications, while in other scenarios, handoff orchestrator 140 may be a service of a particular application, such as source application 120 or destination application 130. Handoff orchestrator 140 may host an API by which agents or applications can transmit user queries and receive handoff links for transferring workflows. For example, an application which does not host an agent may request a handoff link from handoff orchestrator 140 by submitting the request via the API.

Message store 150 is representative of a functionality or service for storing messages for transfer via a message key or identifier. In operation, an application may submit a request to store information in message store 150. Upon receiving the request, message store 150 stores the information and returns a secure message key or identifier by which the information can be retrieved.

Destination application creator 160 is representative of functionality or service, such as an API, for generating links by which to launch an application such as destination application 130 or to create or open a document of an application. In operation, destination application creator 160 may include various parameters in generating the links, such as a parameter for launching an agent when the link is used to launch an application.

Generative AI model 170 is representative of one or more deep learning models or generative pretrained transformer (GPT) computing models or architectures, such as Dall-E, GPT-n, Claude, Gemini, Llama, or other types of deep learning architectures such as state-space models (e.g., Mamba). (Generative AI model 170 is referred to herein in the singular for the case of description, however, it may be appreciated that generative AI model 170 may be representative of multiple AI models with no loss of generality.) Generative AI model 170 is hosted by one or more computing services which provide services by which other elements of operational environment 100 can communicate with the model, such as an API. In communicating with other elements of operational environment 100, generative AI model 170 may send and receive information (e.g., prompts and replies to prompts) in data objects, such as JavaScript Object Notation (JSON) objects. Generative AI model 170 may be implemented in the context of one or more server computers co-located or distributed across one or more data centers. In various implementations, generative AI model 170 is representative of one or more fine-tuned models, such as fine-tuned LLMs, which have been pretrained on domain- or application-specific data. For example, generative AI model 170 may be representative of an LLM which has been fine-tuned for source application 120 and a second LLM which has been fine-tuned for destination application 130.

A brief operational scenario of operational environment 100 follows. In an implementation, a user interacts with source application 120 via a user interface of the application displayed on computing device 110. For example, source application 120 may be a word processing application, and the user may be composing text in the context of a document of source application 120. The user interface displays a chat pane for interacting with source agent 125. The user enters an input in the chat pane which indicates that the user would like to continue developing the content in a new context—as a slide presentation. Source agent 125 receives the user input and prompts generative AI model 170 to generate a response to the user input. The prompt to generative AI model 170 may include contextual information such as an indication of the current context (e.g., a document in a word processing application) as well as the content of the document. In response to the prompt, generative AI model 170 indicates that a handoff to a slide presentation application is indicated. (For this example, it will be assumed that destination application 130 is a slide presentation application.)

Having received the response from generative AI model 170, source agent 125 calls handoff orchestrator 140 to coordinate a handoff of the workflow to destination agent 135. In calling handoff orchestrator 140, source agent 125 includes in its request the user input and/or any preceding conversational history between the user and the agent. The request may also include the document content and the new context (i.e., a slide presentation).

Upon receiving the request from source agent 125, handoff orchestrator 140 stores the information received from source agent 125 in message store 150 and receives a message key for the stored information. Handoff orchestrator 140 also obtains a launch link for launching a blank slide presentation from destination application creator 160. For example, the launch link may be a web address (e.g., a web uniform resource locator (URL)) for a blank slide presentation file which is stored in the cloud storage associated with user's login. The launch link includes a parameter which causes destination application 130 to boot destination agent 135. Handoff orchestrator 140 then configures a handoff link including the message key and the launch link and returns the handoff link to source agent 125 for display in the chat pane.

When the user clicks on the handoff link, the workflow transfer is initiated. Source agent 125 uses the launch link in the handoff link to open the blank slide presentation in destination application 130. Destination application 130 boots destination agent 135 according to the boot parameters in the launch link, and destination agent 135 retrieves the information stored in message store 150 using the message key in the handoff link. The information retrieved from message store 150 (i.e., the user request or conversational history) is streamed to destination agent 135 which continues the workflow in accordance with the user input or conversational history. In some scenarios, the content of the word processing document is also stored with the user input or conversational history in message store 150 to be retrieved by destination agent 135 using the message key. In other scenarios, handoff orchestrator 140 stores an API call to source application 120 by which destination agent 135 can retrieve the document content from source application 120. In still other cases, the API call is embedded as a parameter in the handoff link. In any case, destination agent 135 accesses the document content and supplies the content as contextual information for prompts to generative AI model 170.

With destination application 130 and destination agent 135 open in the user interface of computing device 110, generative AI model 170 is tasked in a prompt or in a series of prompts to design a slide presentation based on the supplied content in accordance with the user request. The user request or conversational history from source agent 125 is used to populate the chat pane of destination agent 135, providing continuity in the workflow for developing the content.

Other use cases illustrate workflow transfers between other types of source and destination contexts or applications. In the following examples, the actions ascribed to the various agents may be performed based on output from a generative AI model in response to prompts which include the user request and workflow content.

In one example, a user working with a dataset in a spreadsheet application may prompt the agent of the spreadsheet application to create a chart of the data. The user may submit a request to the agent requesting a paragraph which summarizes or describes the chart. Based on submitting the user request and spreadsheet content to a generative AI model, the agent may determine that the content should be transferred to the agent of a word processing application. The agent may request a handoff link from a handoff orchestrator for transferring the chart to the agent of a word processing application to transfer the workflow including the user request and a graphical object of the chart to the agent of the word processing application to generate the requested paragraph.

In another scenario, an agent for a web browser may compile information in response to a user search query. The user may request to transfer the compiled information to a word processing document and to include in the document a bibliography of the sources from which the information was gathered. The agent of the web browser may request a handoff link to the agent of a word processing application by which the user can initiate the transfer, causing the agent of the word processing application to create the document and bibliography in accordance with the request.

In yet another scenario, an agent for a project planning application may receive a request from a user to draft an email message which includes a to-do list based on information from a project canvas. Upon generating the to-do list for the project, the agent may request a handoff link from the handoff orchestrator. The request may include information for the various fields of an email message drawn from the project canvas: a list of email addresses of recipients, a text string for the email Subject line, and the to-do list for the body of the email.

Upon receiving the information supplied in the request, the handoff orchestrator may store the information in the message store for retrieval by the email application. The handoff link created by the handoff orchestrator may include parameters for opening a blank email message when the application is launched, and the agent of the email application may receive information from the message store by which to populate the email.

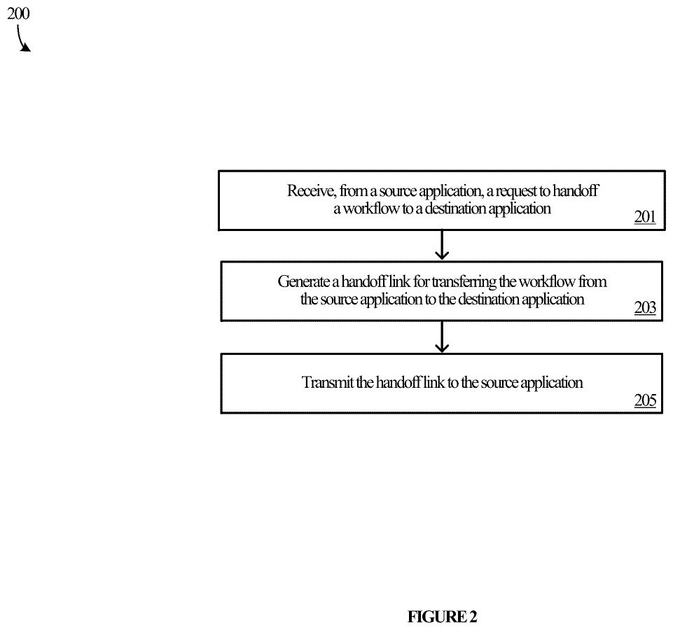

Turning next to FIG. 2, FIG. 2 illustrates a method for transferring workflows between agents in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

In an exemplary scenario, the source application hosts a workflow for a user which involves creating or developing content. In some cases, the user may be generating the workflow content in the source application (e.g., drafting text), or the content may be developed for user by the application. For example, the user may submit inputs which task a generative AI model with generating content, or the user may use a web browser to perform web searches to capture content from the Internet. The source application may host a file, document, or canvas where the user's workflow content is being developed. For example, the source application may be a word processing application, and the user's workflow content may be text drafted by the user in a document of the application.

The source application receives user input in a user interface of the application. For example, the user may interact with an agent of the source application in a chat pane of the user interface where the user can submit inputs to the agent. In some cases, the user may enter the input by keying in the input or speaking the input to a speech-to-text engine which transcribes the input. The agent may be a service or functionality which mediates interactions between the user, the source application, and/or one or more generative AI models. For example, if the user would like assistance in drafting text on a particular topic, the user may submit a query in the chat pane and receive text generated by a generative AI model in response to the query.

When the user input is received in the user interface of the source application, the source application or agent may prompt a generative AI model to generate a response to the user input. The generative AI model may detect that the user input invokes a handoff of the workflow from the current context (i.e., the source application) to a new context, such as another type of software application for developing the workflow content in a manner which the current context does not support. Upon determining that a handoff is invoked in the user input, the source application or application agent transmits a request to a computing device to create a handoff.

A computing device receives a request to hand off a workflow to a destination application (step 201). In an implementation, the computing device receives a request for a handoff or a handoff link from a source application or an agent of the source application (“source agent”). The computing device may, for example, execute a handoff orchestrator for receiving handoff requests. The request may include the user's natural language input received by the source application or source agent which invokes the handoff as well as other information relating to the workflow, such as the destination context or destination application and the workflow content for which the user input is invoking the change in context. In some scenarios, the user input may be a selection by the user of a graphical element for transferring the workflow, e.g., clicking a “Share” button.

In various implementations, the request specifies the destination application or destination context to receive the workflow handoff. For example, a generative AI model may be prompted by the source agent to generate a response to the user input. In determining that a handoff is invoked in the user input, the generative AI model may also identify a destination context or destination application to which the workflow should be transferred. Based on the response from the generative AI model, the source agent may specify the destination context or destination application for the handoff in the request.

In some scenarios, the computing device may begin process 200 in response to receiving a request for a workflow handoff via an API call from source application 120 irrespective of a user input invoking the handoff or in response to a user input that is different from a natural language text input (e.g., clicking a button). For example, the handoff orchestrator executed by the computing device may host an API by which to receive handoff requests from applications and to return handoff links in response to the requests. In some cases, the handoff orchestrator may be hosted by an application service and may be callable by agents of a suite of applications of the application service hosting the handoff orchestrator. A third-party application (i.e., an application external to the suite of applications) may also transmit a handoff request via the API of the handoff orchestrator to receive handoff links to applications within the suite of applications.

Continuing with process 200, the computing device generates a handoff link for handing off the workflow from the source application to the destination application (step 203). In an implementation, the handoff orchestrator executed by the computing device receives the request for transferring a workflow to a destination application. The handoff orchestrator creates a handoff link by which to execute the handoff in response to the request. To create the handoff link, the handoff orchestrator calls an API of the destination application to receive a launch link for launching the destination application. The launch link may be a web URL for a blank document of the destination application which can be used to launch the destination application. The handoff orchestrator also submits information from the request to a message store which the destination application can retrieve using a message key. For example, the handoff orchestrator may store the user input or conversational history between the user and the source agent in the message store along with workflow content (i.e., the content to be transferred to the new context). The workflow content may be stored in the message store in a markdown format for portability between different application types. Alternatively, the handoff orchestrator may store an API call to the source application by which the destination application can retrieve the workflow content (rather than storing the workflow content in the message store).

The handoff orchestrator constructs a handoff link which includes the launch link and the message key. In various implementations, the handoff link also includes a parameter which causes the destination application to launch its agent (“destination agent”) for receiving the transferred workflow. In some scenarios, the handoff link is assembled based on a response from a generative AI model. For example, the generative AI model may be tasked with constructing and returning a handoff link based on the information provided, such as the launch link, the message key, and the boot parameter.

With the handoff link assembled, the computing device transmits the handoff link to the source application (step 205). In an implementation, the computing device returns the handoff link to the source application or source agent which displays in the link as a hyperlink in the user interface of the application. In the user interface, the user sees a hyperlink which, when clicked, will initiate a process of transferring the workflow to the destination agent.

When the user clicks the handoff link, the source application or source agent executes the launch link to launch the destination application and the destination agent. The destination agent retrieves the information stored in the message store using the message key. The destination agent receives the user input or conversational history retrieved from the message stored and workflow content or the API call to retrieve the workflow content from the source application.

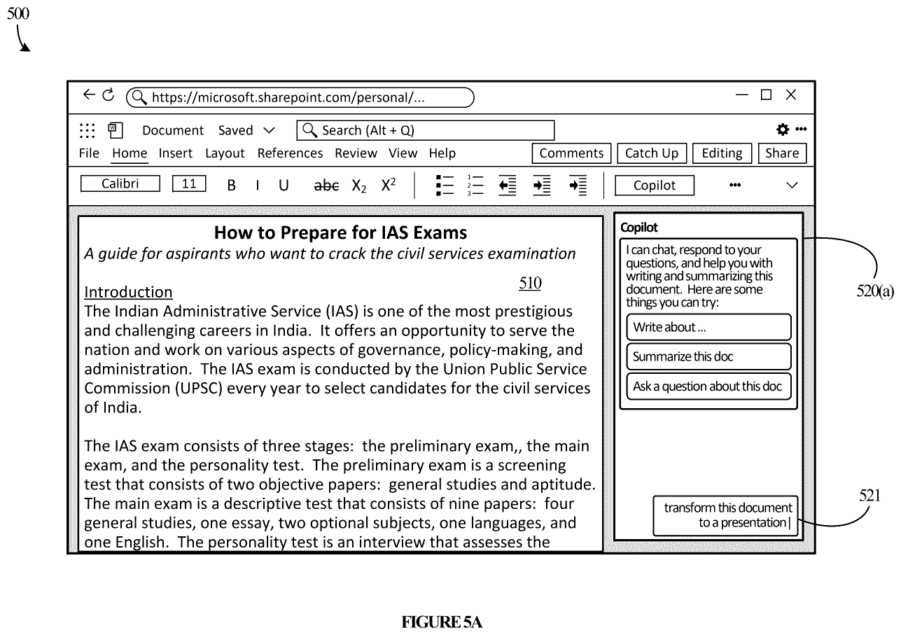

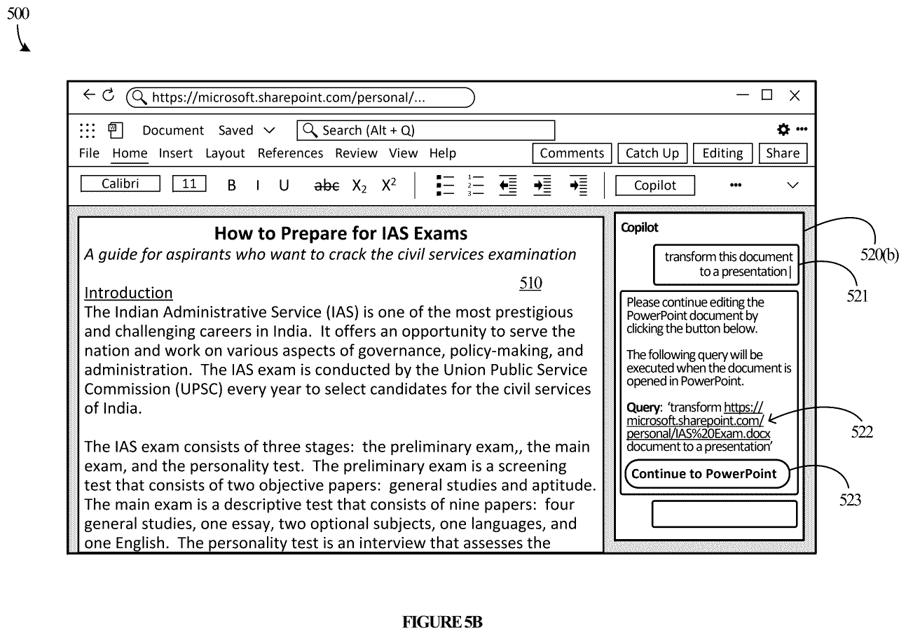

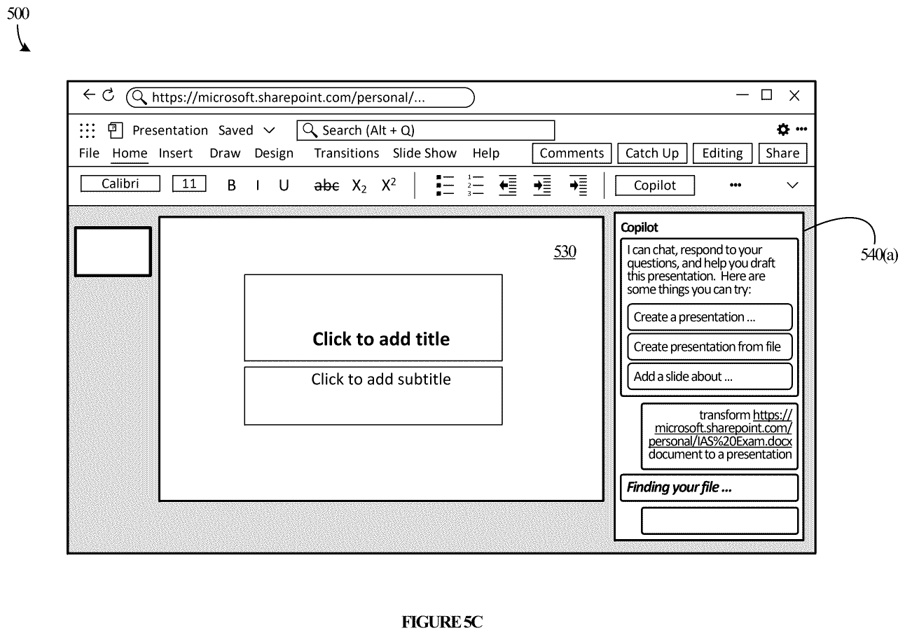

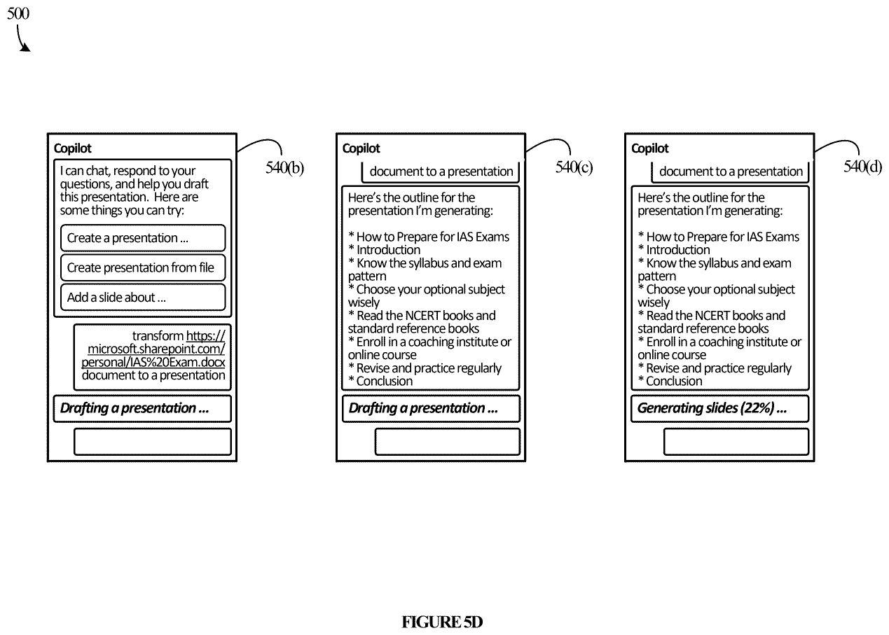

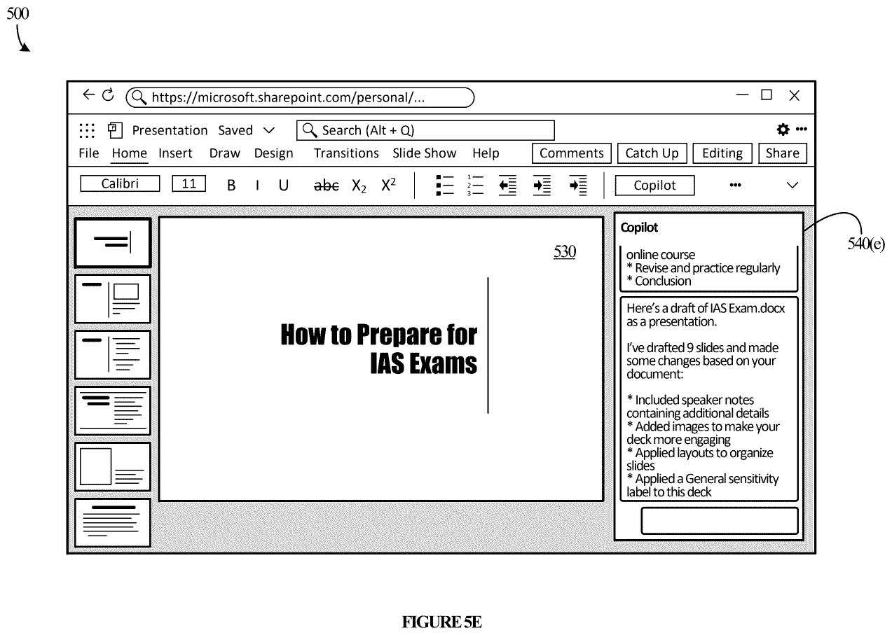

Upon ingesting the user input or conversational history from the message store, the destination agent picks up where the workflow engagement with the source agent left off. For example, the destination agent picks up the workflow where the user input invoked the handoff and prompts the generative AI model to recontextualize the workflow content to the new context. By providing the conversational history preceding the handoff invocation, the destination agent is able to effect a virtually seamless workflow transfer and content transformation from the source context to the destination context from the perspective of the user as is illustrated in FIGS. 5A-5E discussed infra.

Referring again to FIG. 1, operational environment 100 includes a brief example of process 200 as employed by elements of operational environment 100 in an implementation. Computing device 110 executes source application 120 including source agent 125. Source application 120 may execute locally with respect to computing device 110, or computing device 110 may host source application 120 which executes on one or more server computing devices remote from and in communication with computing device 110, or source application 120 may execute in distributed, client-server fashion.

In operation, source agent 125 calls handoff orchestrator 140 to execute elements of process 200 for transferring a workflow to a destination application, such as destination application 130. In an implementation, source agent 125 detects that a user input received in the user interface of source application 120 invokes or desires to invoke a transfer of a subject workflow to a destination agent 135 of destination application 130. For example, the user wishes to transfer the workflow to further develop content in a new context and expresses that intent in a user input to source agent 125. Of course, given the fluidity of natural language, discerning such an intent in a user input is a task well-suited to the semantic understanding of generative AI models. When provided a list of destination applications for continuing the workflow according to the user's intent, the generative AI model can select the most appropriate application to carry forward the workflow.

Upon receiving the user input and discerning the handoff invocation, source agent 125 sends a request to handoff orchestrator 140 requesting a handoff or to transfer the workflow to another application. Handoff orchestrator 140 receives the request and, in response, generates a handoff link by which agent 125 can transfer the workflow. To generate the handoff link, handoff orchestrator 140 performs process 200, to wit, obtaining a launch link for destination application 130, storing workflow information (e.g., user input or conversational history, workflow content) in message store 150, and constructing the handoff link along with a boot parameter for launching destination agent 135.

With the handoff link configured, handoff orchestrator 140 transmits the handoff link to source agent 125. Source agent 135 displays a graphical element (e.g., button or hyperlink) for the handoff link by which the user can initiate the workflow transfer. The handoff link, when executed, causes destination application 130 to open with a blank document or canvas and causes destination agent 135 to open and ingest the user input or conversational history from message store 150. Having ingested the preceding interaction of the user with source agent 125 causes destination agent 135 to prompt generative AI model 170 to generate output to continue the workflow in the new context, including recontextualizing or transforming the workflow content to the context of the blank document or canvas of destination application 130.

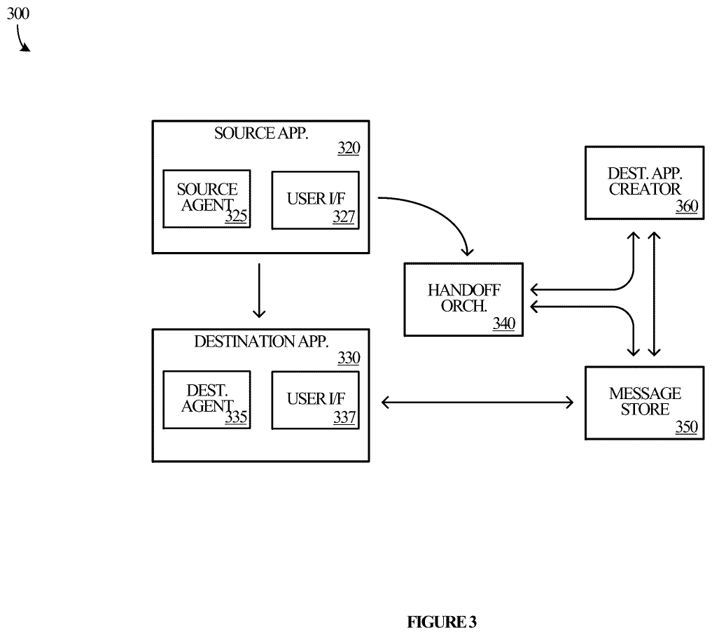

Turning now to FIG. 3, FIG. 3 depicts operational environment 300 for transferring a workflow from an agent of a source application to an agent of a destination application in an implementation. Operational environment 300 includes

In operational environment 300, source application 320, of which source application 120 of FIG. 1 is representative, hosts source agent 125 and user interface 327. User interface 327 may be displayed in a user computing device, such as computing device 110 of FIG. 1. Destination application 330, of which destination application 130 of FIG. 1 is representative, hosts destination agent 135, user interface 337, and destination application creator 360. Operational environment 300 also includes handoff orchestrator 340 and message store 350. Handoff orchestrator 340, of which handoff orchestrator 140 of FIG. 1 is representative, and message store 350, of which message store 150 of FIG. 1 is representative, may be services hosted by an application service in communication with source application 320 and destination application 330. For example, source application 320 and destination application 330 may be applications of a suite of applications which subscribe to inter-application services such as handoff orchestrator 340 and/or message store 350. Alternatively, in some implementations, handoff orchestrator 340 and/or message store 350 may be services of an application such as destination application 330.

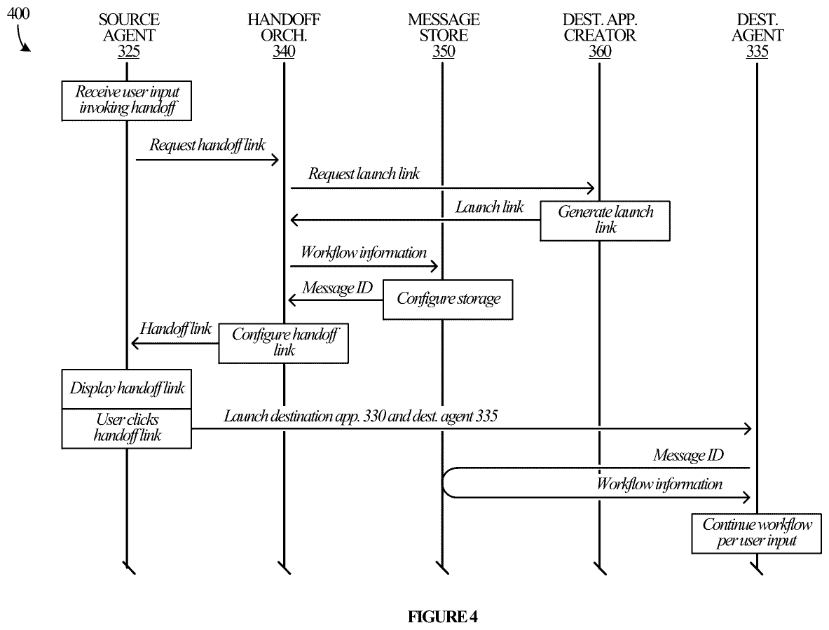

FIG. 4 illustrates process 400 for transferring a workflow from an agent of a source application to an agent of a destination application, referring to elements of operational environment 300 of FIG. 3 in an implementation.

In process 400, source agent 325 receives a user input invoking a handoff of a workflow hosted by source agent 325. The user input may be a natural language query entered in user interface 327 or user selection of a graphical element in user interface 327 which initiates a handoff to another application. The workflow may be a conversational exchange between source agent 325 (e.g., as a proxy for a generative AI model) and a user. In some scenarios, the workflow may comprise a conversational exchange between the user and a generative AI model which is mediated by source agent 325. The workflow may also be a series of actions performed by source application agent 325 or output generated by source agent 325 in response to inputs received from a user and in relation to some workflow content. The workflow content may be content created by or developed by the user possibly with assistance from source agent 325 or from a generative AI model via source agent 325.

Source agent 325 determines that the user input invokes a handoff. To determine that the user input includes an invocation, source agent 325 submits the user input to a generative AI model which determines that the user desires to transfer the current workflow to destination agent 335. In other words, the user wants to transfer the conversational exchange between the user and source agent 325, along with any associated content, from the context of the agent of the web browser to the agent of a word processing application. Based on determining that the user is invoking a handoff, source agent 325 transmits a request to handoff orchestrator 340 for a handoff of the current workflow from source agent 325 to destination agent 335.

The following exemplary scenario is offered to illustrate process 400 thus far. A user enters an input to the application agent of a web browser application seeking recommendations for locations for bird watching. Upon receiving output generated by the browser agent based on search results from the web browser, the user clicks a button to transfer or “share” the generated content to a word processing document. In submitting the input to transfer the content to a word processing document, the browser agent sends a request for a handoff link to a handoff orchestrator, such as handoff orchestrator 340.

Continuing with process 400, handoff orchestrator 340 receives the request and initiates a process for constructing a handoff link for the requested handoff. Handoff orchestrator 340 requests a launch link from destination application creator 360. Destination application creator 360 configures a link and returns the link to handoff orchestrator 340. In an implementation, destination application creator 360 may create a blank document (or file, canvas, etc.) for destination application 330 in a cloud storage associated with the user's application service account or login. Destination application creator 360 then returns the URL for the blank document to handoff orchestrator 340. When activated, the URL launches destination application 330 and opens the blank document in the application.

Handoff orchestrator 340 also sends workflow information from the request to message store 350 for storage. Handoff orchestrator 340 may store the conversational exchange between the user and source agent 325 in message store 350, including any content developed during the exchange. Handoff orchestrator 340 may also store content that the user is developing in source application 320 to which the conversational exchange relates. When message store 350 stores the information supplied by handoff orchestrator 340, it returns a message identifier by which the information can be retrieved from storage.

Referring back to the illustrative example above, in response to the user input to transfer the generated content about recommended locations for bird watching to a word processing document, the handoff orchestrator stores the generated content along with the sources produced by the web browser in a message store and obtains a launch link for opening a blank document to receive content generated during the workflow in a word processing application.

Next, handoff orchestrator 340 constructs a handoff link for launching destination application 330 including the launch link and the message identifier. The handoff link may include a parameter which causes destination application 330 to open destination agent 335. Handoff orchestrator 140 returns the handoff link to source agent 325 for display in the user interface, e.g., as a graphical button or hyperlink.

When the user clicks on or otherwise causes the handoff link to execute, source agent 325 executes the launch link to launch destination application 330 and destination agent 335 in destination application 330. When launched, destination agent 335 accesses the information stored in message store 350 according to the message identifier provided in the handoff link. Destination agent 335 ingests the conversational exchange retrieved from message store 350 and continues the workflow embodied therein.

Referring once again to the illustrative example above, the word processing agent may continue the workflow by prompting a generative AI model to draft a blurb for travel brochure based on the content generated based on the workflow thus far (i.e., the recommended locations for bird watching based on the conversation with the browser agent) and to generate a bibliography of the sources used by the browser agent in generating the content.

FIGS. 5A-5E illustrate user experience 500 for transferring a workflow from the agent of a source application to the agent of a destination application in an implementation according to the technology disclosed herein.

User experience 500 of FIG. 5A includes depicts a user interface of a word processing application (e.g., Microsoft Word). The user interface displays document 510 and includes chat pane 520 by which the user can interact with an agent (e.g., Copilot). The agent interfaces with a generative AI model to assist the user in developing content, such as drafting or editing text in document 510.

As illustrated in FIG. 5A, the user has entered user input 521 in chat pane 520 (a) requesting to “transform this document to a presentation.” The agent receives user input 521 and prompts the generative AI model to generate a recommended response. The generative AI model determines that user input 521 indicates that the user wishes to transfer the workflow to another context-a slide presentation. The generative AI model returns output indicating that user input 521 is invoking a handoff and that the workflow and content should be transferred to a presentation application (e.g., Microsoft PowerPoint). Based on the output from the generative AI model, the agent sends a request to a handoff orchestrator to generate a handoff link for executing the transfer, e.g., as described in process 200.

FIG. 5B illustrates chat pane 520 (b) based on the output generated by the generative AI model in response to user input 521. In chat pane 520 (b), the agent describes the action that will be performed when the user clicks button 523, that the content of document 510 in the file at the indicated web address will be “transformed” into a presentation per user input 521. In chat pane 520 (b), button 523 executes the handoff link for executing the transfer to the presentation application based on user input 521. When clicked by the user, button 523 (i.e., the handoff link) will transfer the workflow and content of document 510 to the new context. Continuing the exemplary scenario, the user clicks button 523 to continue the workflow of content development in the new context.

In FIG. 5C, user experience 500 transfers to the presentation application. When the user clicked button 523 to initiate the transfer, a blank slide of the newly created slide deck 530 is opened in the user interface of the application. Chat pane 540 (a) is also opened in the user interface which allows the user to continue the workflow (creating a slide presentation based on document 510) as slide deck 530.

In chat pane 540 (a), the agent of the presentation application has ingested the conversational exchange from chat pane 520 (b) and picks up where the workflow left off. The agent retrieves content of document 510 according to its web address as shown in chat pane 520 (b).

Continuing to FIG. 5D, having retrieved the content of document 510 and ingested the user request to create a slide presentation, the presentation agent engages in an interaction with the generative AI model to develop slide deck 530. As illustrated in chat pane 540 (b), the agent prompts the generative AI model to generate an outline for the presentation based on the content of document 510. Next, in chat pane 540 (c), the agent displays the AI-generated outline and prompts the generative AI model to develop content for slide deck 530 based on the outline. Proceeding to chat pane 540 (d), the agent generates the slides according to the slide content generated by the generative AI model. In FIG. 5E, a completed version of slide deck 530 is surfaced in the user interface. In chat pane 540 (c), the agent summarizes the steps taken to complete the workflow in transforming the content of document 510 into slide deck 530.

In an alternative implementation of the scenario described in FIGS. 5A-5E, as the user is developing content in the word processing application, the agent may present the user with the option to transfer development of the content to other contexts or in other formats. For example, in the example scenario illustrated in FIGS. 5A-5E, rather than receiving user input 521 as a natural language entry keyed in by the user, chat pane 520 may display a button labeled “Create a slide presentation” which, when clicked, causes the agent to send a request to the handoff orchestrator for the handoff link.

FIG. 6 illustrates computing device 601 that is representative of any system or collection of systems in which the various processes, programs, services, and scenarios disclosed herein may be implemented. Examples of computing device 601 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 601 may be implemented as a single apparatus, system, or device or may be implemented in a distributed manner as multiple apparatuses, systems, or devices. Computing device 601 includes, but is not limited to, processing system 602, storage system 603, software 605, communication interface system 607, and user interface system 609 (optional). Processing system 602 is operatively coupled with storage system 603, communication interface system 607, and user interface system 609.

Processing system 602 loads and executes software 605 from storage system 603. Software 605 includes and implements handoff process 606, which is (are) representative of the handoff processes discussed with respect to the preceding Figures, such as processes 200 and 400. When executed by processing system 602, software 605 directs processing system 602 to operate as described herein for at least the various processes, operational scenarios, and sequences discussed in the foregoing implementations. Computing device 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 include general purpose central processing units, graphical processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 (including handoff process 606) may be implemented in program instructions and among other functions may, when executed by processing system 602, direct processing system 602 to operate as described with respect to the various operational scenarios, sequences, and processes illustrated herein. For example, software 605 may include program instructions for implementing a handoff process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing device 601 is representative) overall from a general-purpose computing system into a special-purpose computing system customized to support handing off workflows in an optimized manner. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

### Examples

The following illustrative examples are mentioned not to limit or define the scope of the disclosure but rather to provide examples to aid understanding thereof. Illustrative examples are discussed above in the Detailed Description which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising one or more computer readable storage media; one or more processors operatively coupled with the one or more computer readable storage media; and program instructions stored on the one or more computer readable storage media that, when executed by the one or more processors, direct the computing apparatus to at least receive, from a source application, a request to hand off a workflow to a destination application; in response to the request, generate a handoff link for transferring the workflow from the source application to the destination application; and transmit the handoff link to the source application.

Example 2 is the computing apparatus of any previous or subsequent Example, wherein the handoff link comprises at least a launch link for launching the destination application and a message identifier for accessing workflow information stored in a message store.

Example 3 is the computing apparatus of any previous or subsequent Example, wherein to generate the handoff link, the program instructions direct the computing apparatus to receive, from an application programming interface of the destination application, the launch link for launching the destination application; and receive, from the message store, the message identifier in response to storing the workflow information in the message store.

Example 4 is the computing apparatus of any previous or subsequent Example, wherein the handoff link further comprises a boot parameter for launching an agent of the destination application.

Example 5 is the computing apparatus of any previous or subsequent Example, wherein the launch link comprises a web address for a document of the destination application.

Example 6 is the computing apparatus of any previous or subsequent Example, wherein the request comprises at least a conversational exchange between a user and an agent of the source application.

Example 7 is the computing apparatus of any previous or subsequent Example, wherein to receive the request to handoff the workflow to the destination application, the program instructions direct the computing apparatus to receive the request from an agent of the source application based on a response from a generative artificial intelligence model, wherein the response indicates that a handoff is invoked by a user input.

Example 8 is a method of operating a computing system, comprising receiving, from a source application, a request to hand off a workflow to a destination application; in response to the request, generating a handoff link for transferring the workflow from the source application to the destination application; and transmitting the handoff link to the source application.

Example 9 is the method of any previous or subsequent method, wherein the handoff link comprises at least a launch link for launching the destination application and a message identifier for accessing workflow information stored in a message store.

Example 10 is the method of any previous or subsequent method, wherein generating the handoff link comprises receiving, from an application programming interface of the destination application, the launch link for launching the destination application; and receiving, from the message store, the message identifier in response to storing the workflow information in the message store.

Example 11 is the method of any previous or subsequent method, wherein the handoff link further comprises a boot parameter for launching an agent of the destination application.

Example 12 is the method of any previous or subsequent method, wherein the launch link comprises a web address for a document of the destination application.

Example 13 is the method of any previous or subsequent method, wherein the request comprises at least a conversational exchange between a user and an agent of the source application.

Example 14 is the method of any previous or subsequent method, wherein receiving the request to handoff the workflow to the destination application comprises receiving the request from an agent of the source application based on a response from a generative artificial intelligence model, wherein the response indicates that a handoff is invoked by a user input.

Example 15 is one or more computer-readable storage media having program instructions stored thereon that, when executed by one or more processors of a computing device, direct the computing device to at least receive, from a source application, a request to hand off a workflow to a destination application; in response to the request, generate a handoff link for transferring the workflow from the source application to the destination application; and transmit the handoff link to the source application.

Example 16 is the one or more computer-readable storage media of any previous or subsequent Example, wherein the handoff link comprises at least a launch link for launching the destination application and a message identifier for accessing workflow information stored in a message store.

Example 17 is the one or more computer-readable storage media of any previous or subsequent Example, wherein to generate the handoff link, the program instructions direct the computing apparatus to receive, from an application programming interface of the destination application, the launch link for launching the destination application; and receive, from the message store, the message identifier in response to storing the workflow information in the message store.

Example 18 is the one or more computer-readable storage media of any previous or subsequent Example, wherein the handoff link further comprises a boot parameter for launching an agent of the destination application.

Example 19 is the one or more computer-readable storage media of any previous or subsequent Example, wherein the launch link comprises a web address for a document of the destination application.

Example 20 is the one or more computer-readable storage media of any previous or subsequent Example, wherein the request comprises at least a conversational exchange between a user and an agent of the source application.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
receive, from a source application, a request to hand off a workflow to a destination application;
in response to the request, generate a handoff link for transferring the workflow from the source application to the destination application; and
transmit the handoff link to the source application.

2. The computing apparatus of claim 1, wherein the handoff link comprises at least a launch link for launching the destination application and a message identifier for accessing workflow information stored in a message store.

3. The computing apparatus of claim 2, wherein to generate the handoff link, the program instructions direct the computing apparatus to:
receive, from an application programming interface of the destination application, the launch link for launching the destination application; and
receive, from the message store, the message identifier in response to storing the workflow information in the message store.

4. The computing apparatus of claim 3, wherein the handoff link further comprises a boot parameter for launching an agent of the destination application.

5. The computing apparatus of claim 4, wherein the launch link comprises a web address for a document of the destination application.

6. The computing apparatus of claim 1, wherein the request comprises at least a conversational exchange between a user and an agent of the source application.

7. The computing apparatus of claim 1, wherein to receive the request to handoff the workflow to the destination application, the program instructions direct the computing apparatus to receive the request from an agent of the source application based on a response from a generative artificial intelligence model, wherein the response indicates that a handoff is invoked by a user input.

8. A method of operating a computing device comprising:
receiving, from a source application, a request to hand off a workflow to a destination application;
in response to the request, generating a handoff link for transferring the workflow from the source application to the destination application; and
transmitting the handoff link to the source application.

9. The method of claim 8, wherein the handoff link comprises at least a launch link for launching the destination application and a message identifier for accessing workflow information stored in a message store.

10. The method of claim 9, wherein generating the handoff link comprises:
receiving, from an application programming interface of the destination application, the launch link for launching the destination application; and
receiving, from the message store, the message identifier in response to storing the workflow information in the message store.

11. The method of claim 10, wherein the handoff link further comprises a boot parameter for launching an agent of the destination application.

12. The method of claim 11, wherein the launch link comprises a web address for a document of the destination application.

13. The method of claim 8, wherein the request comprises at least a conversational exchange between a user and an agent of the source application.

14. The method of claim 8, wherein receiving the request to handoff the workflow to the destination application comprises receiving the request from an agent of the source application based on a response from a generative artificial intelligence model, wherein the response indicates that a handoff is invoked by a user input.

15. One or more computer-readable storage media having program instructions stored thereon that, when executed by one or more processors, direct a computing apparatus to at least:
receive, from a source application, a request to hand off a workflow to a destination application;
in response to the request, generate a handoff link for transferring the workflow from the source application to the destination application; and
transmit the handoff link to the source application.

16. The one or more computer-readable storage of claim 15, wherein the handoff link comprises at least a launch link for launching the destination application and a message identifier for accessing workflow information stored in a message store.

17. The one or more computer-readable storage media of claim 16, wherein to generate the handoff link, the program instructions direct the computing apparatus to:
receive, from an application programming interface of the destination application, the launch link for launching the destination application; and
receive, from the message store, the message identifier in response to storing the workflow information in the message store.

18. The one or more computer-readable storage of claim 17, wherein the handoff link further comprises a boot parameter for launching an agent of the destination application.

19. The one or more computer-readable storage of claim 18, wherein the launch link comprises a web address for a document of the destination application.

20. The one or more computer-readable storage of claim 15, wherein the request comprises at least a conversational exchange between a user and an agent of the source application.
